(19) United States
(12) Patent Application Publication
(10) Pub. No.: US 2013/0263484 A1
(43) Pub. Date: Oct. 10, 2013

(54) FLOOR DISPLAY

(71) Applicant: Johan Marius TRYK, Haderslev (DK)

(72) Inventor: Johan Marius TRYK, Haderslev (DK)

(21) Appl. No.: 13/793,797

(22) Filed: Mar. 11, 2013

Related U.S. Application Data
(63) Continuation of application No. 13/146,448, filed on Sep. 6, 2011, now abandoned.

(30) Foreign Application Priority Data
Feb. 5, 2010 (DK) PA200900167

(51) Int. Cl. G09F 19/00

(52) U.S. Cl. CPC G09F 19/00
USPC 40/541; 40/606.01

(57) ABSTRACT

The present invention relates to a floor display comprising a floor panel, which panel comprises an upper surface, which upper surface of the panel mostly follows a line from the front of the bottom surface to the top of the side surface, hereby forming an inclined panel. It is the object of the invention to achieve a floor display at the floor in shops or supermarkets. This object can be achieved with a floor display if the upper surface of the panel forms a display area, which display surface comprises a transparent cover, which transparent cover is fixed to the panel at the panel front and at the side surface against the wall or shelf. It can hereby be achieved that the floor near walls or shelves is used for advertisement. As for all customers in shops or supermarkets, the floor is a very important place to use for advertisement.

### CROSS-REFERENCE TO RELATED APPLICATION

This patent application is a continuation of and claims the benefit of U.S. patent application Ser. No. 13/146,448, filed Sep. 6, 2011, which in turn is a 371 of international application number PCT/DK2010/050036, filed Feb. 5, 2010, which in turn claims priority to Denmark Application Number PA200900167, filed Feb. 5, 2009. Each of the aforementioned patent applications is incorporated by reference herein in its entirety for any purpose whatsoever.

### FIELD OF THE INVENTION

The present invention relates to a floor display comprising a floor panel, which floor display comprises a bottom surface to be placed at the floor, a side surface to be placed against a wall or a shelf, which panel comprises an upper surface, which upper surface of the panel mostly follows a line from the front of the bottom surface to the top of the side surface, herby forming an inclined panel.

### BACKGROUND OF THE INVENTION

Advertisement at a floor is known as painted text or pictures directly at the floor in a shop or supermarket. Furthermore, mats may comprise text. None of the existing advertisement methods are formed in a way in which information is changeable.

WO 2005/104535 concerns a method of presenting an image to be placed at a predetermined image position and optimised for viewing floral a predetermined viewing position. The image is first transformed by application of an inverse prospective transformation to compensate for natural perspective effects when the image is placed at the predetermined image position and viewed along a line of sight from the predetermined viewing position. The image is then inclined towards the predetermined viewing position at an acute angle to the horizontal. The angle of inclination may be as little as 1 to 7°.

CA 2,176,329 concerns a floor mat having a transparent first sheet overlaid upon a second sheet and sealed about a perimeter edge to define a pocket for receiving an advertisement. A water resistant releasable closure is associated with the first and second sheets to facilitate access to the pocket. Further embodiments provide an electro-luminescent lamp and/or an audio emitter being disposed within the pocket.

U.S. Pat. No. 6,233,776 describe an advanced floor mat. In an embodiment of the present invention, the floor mat includes a cleanable portion. The floor mat may also include a water dissipation component, a water absorbing component, a cushioning component, customized graphics, a transparent cleanable portion, a tacky surface on the cleanable portion, an antibacterial composition, an antifungal composition, and a fragrance. The cleanable portion may be erodible and may include a plurality of cleanable reusable layers. If a tacky surface is included in the floor mat, an anti-slip feature may be associated with the tacky surface to help prevent slipping on a possibly wet tacky surface. Additionally, a sensor system may be included in the floor mat to assist a user in identifying when the floor mat may require cleaning.

### OBJECT OF THE INVENTION

It is the object of the invention to achieve a floor display at the floor in shops or supermarkets. A further object of the pending patent application is to close an opening between the floor and a low placed shelf in a shop to reduce the cleaning burden below lower shelves.

### DESCRIPTION OF THE INVENTION

This object can be achieved with a floor display as described in the preamble to claim 1 if the upper surface of the panel forms a display area, which display surface comprises a transparent cover, which transparent cover is fixed to the panel at the panel front and at the side surface against the wall or shelf.

It can hereby be achieved that the floor near walls or shelves is used for advertisement. As for all customers in shops or supermarkets, the floor is a very important place to use for advertisement. Walking on a floor, people will pay attention to the floor in order not to stumble over goods placed on the floor. It is probably a natural, human instinct when walking that we have to look down to see the ground in order to walk safely. Therefore, advertisements placed on the floor have much more effect than any advertisement placed upwards in shops or supermarkets e.g. as electronic displays placed high in the room. Placing a floor display near a wall or a shelf, it is placed in areas where people are probably not walking, and if they use roller baskets in supermarkets, these roller baskets will probably not touch the floor display as they are placed relatively close to a shelf or a wall. Using a transparent cover over the display media as such also gives the benefit that the floor display is stable and can be used for walking.

In a preferred embodiment for the invention, the floor display comprises reinforcement braces connecting the top and bottom of the panel. The floor display can be formed of different materials, but even if it is made of metal e.g. titanium or aluminium, it is necessary to reinforce the inner of a panel. This can be achieved by reinforcement by brace connections between top and bottom of the panel. By using efficient reinforcement, plastic materials can also be used for a floor display.

The front of the floor display can comprise a protrusion, which protrusion overlays the front of the transparent cover. The transparent cover has to be fixed at the floor display but in a way which allows it to be removed so that the display media below is changeable. The front of the floor display is of course the most critical part of the floor display as such as this is the area which will be hit by walking or by roller baskets. In order not to let the front edge of the cover be unprotected, it is very important that the front comprises a protrusion which protects the front end of the cover.

Furthermore, the side surface of the floor display can comprise an upwards directed hook for fastening the back of the transparent cover. At the side surface fastening means are also necessary for fixation of a transparent cover. One possibility is to use a hook, and if the transparent cover is flexible, there might be bending forces in the cover that keep the end of the cover in the hook.

It is preferred that the transparent cover is made of polycarbonate. Many different transparent, materials could be used for the cover, but one of the best materials is polycarbonate. This material can be transparent, and it is one of the best materials for protecting the display media below. Polycarbonate will not break if somebody is standing on the surface. It could be sensible to scratches so during the life of a floor display, there is no doubt that even if a cover is made of polycarbonate, it will have to be replaced sooner or later.

A space for accommodation of a display media can be formed in the floor display below the transparent cover. The space necessary for the display media, if the display media is a printed information page comprising advertisement, does not need to be deep, but different forms for display medias are possible.

The display media can be a printed picture. The simplest form for generating information is to use a printed, picture for advertisement. These printed pictures can be replaced at the floor panel by removing the cover and replacing the printed picture.

Instead, the display media can be an electronic display. By using a polycarbonate cover, it is possible to place an electronic display in a pocket below the transparent cover. This could be in the form of a LED display such as a typical flat computer screen or a flat television screen. By using electronic displays, it is possible to show video compositions at the floor media. Different kinds of light shows could also be formed if the display media is an electronic display. By using ordinary, digital pictures, all kinds of advertisement could be formed at the display and the change of advertisements could be performed from a central computer in a supermarket.

The bottom of the floor display can comprise at least one recess for accommodation of a protrusion, which protrusion is part of a longitudinal frame fastened to the floor. In particular if the floor display comprises relatively expensive, electronic displays, it is very important that the floor display is fixed to the floor, and that the frame could be formed as a strip e.g. of metal fastened to the ceiling. In this way, the floor display could be locked to the floor.

The floor display can comprise a computer controlled display, which display is covered by a full or partly transparent cover. Hereby, it can be achieved that e.g. a computer-based or video-based film sequence can be shown at the floor display. Combining a different computer controlled displays can combine the operations of the different displays so that they work more or less than one combined display. In that way, a different kind of movement along the floor could be indicated as part of a light show. Also, combined e.g. with photo sensors, it is possible to start a video show each time a customer approaches the floor display. In that way, it is possible to give a customer further product information about a product placed on a shelf above the display. Detectors could be placed in the front of shelves so that attention e.g. by customers touching or approaching one of the shelves will automatically switch on the computer-based or video-based sequence related to that product. In other situations, it will be possible to place activation switches which can start the video sequence around the products at shelves.

The floor display can comprise a number of LED-based light sources placed below a full or partly transparent cover. Hereby, it is possible to perform a kind of light show in the floor display. The LEDs might be made of a group of LEDs so that they can generate light in different colours. Depending on the number of LEDs and how close they are placed to each other, it is also possible to show computer-based information of a LED-based floor display.

The floor display can comprise a cable tray for power or data cables. The open space below a floor display can be used for power supply for a whole shelf where light e.g. for other lamps or maybe intelligent price indication displays on the shelves have to be coupled to new cables which have to be connected to the floor. It is by the floor panel possible to find a quite new road for cabling.

The floor display can comprise a hinge in the front end for adjustment of the inclined panel in order to fit shelves at different heights over the floor. By letting a floor display be flexible, the floor display could be used for direct contact with the lower shelf in a display system but as the lower shelf might in different set-ups be adjustable, it is highly efficient that the angle of a floor display is variable. This can be achieved especially if the front end is a hinge that allows adjustment of the inclination.

### DESCRIPTION OF THE DRAWING

FIG. 1 shows a floor display, and

FIG. 2 shows a sectional view of a floor display, and

FIG. 3 shows corner sections forming an outside corner, and

FIG. 4 shows an end section, and

FIG. 5 shows an alternative end section, and

FIG. 6 shows the end section of FIG. 5 with fastening means.

FIG. 7 shows an alternative embodiment.

FIG. 8 shows an alternative embodiment to FIG. 7.

FIG. 9 shows a combination of a two layers floor display.

FIG. 10 shows a further alternative embodiment for the invention.

FIG. 11 shows a magnified indication of the front.

FIG. 12 shows the upper corner of FIG. 11.

FIG. 13 shows a downward corner of FIG. 11.

FIG. 14 shows an alternative embodiment for the invention in a movable floor display.

FIG. 15 shows the same embodiment as FIG. 14 of the moveable floor display.

FIG. 16 shows a sectional view of a moveable floor display.

FIG. 17 shows the moveable floor display 400 partly separated.

FIG. 18 shows an elevated floor 500 operating with floor displays around the three sides.

FIG. 19 shows the floor display seen from the side where it is connected to the floor.

FIG. 20 shows the elevated floor in combination with floor display.

FIG. 21 shows the same elevated floor with the floor display but without floor plates.

FIG. 22 shows two separated corner sections.

FIG. 23 shows the elevated floor.

FIG. 24 shows another embodiment for a corner.

FIG. 25 shows a sectional view of a floor display.

FIG. 26 shows the longitudinal component.

FIG. 27 shows different mechanical components.

### DETAILED DESCRIPTION OF THE INVENTION

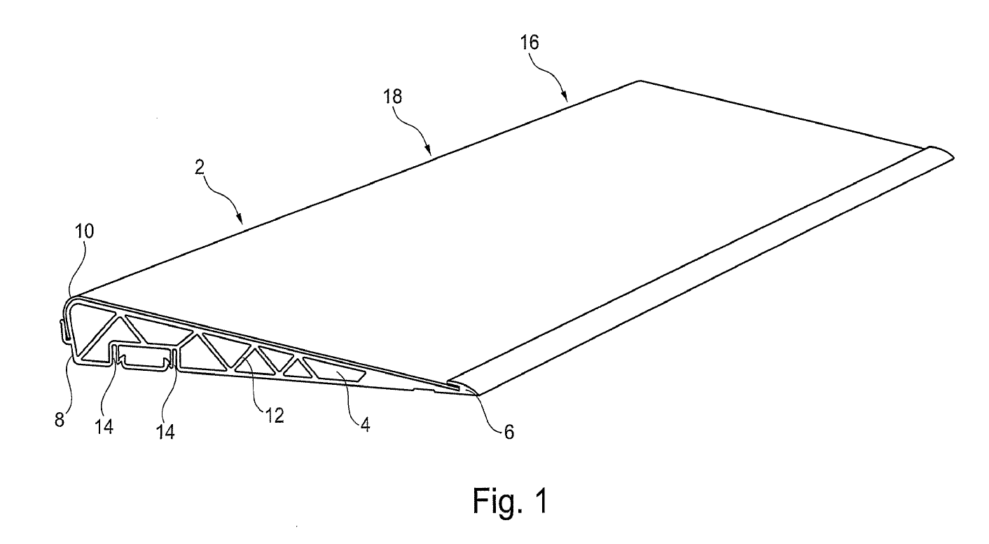

FIG. 1 shows a floor display 2 which floor display 2 comprises a downward surface 4, a front 6 and a side 8. The floor display further comprises a cover 10 and inside the panel, reinforcement braces 12 are shown. Furthermore, longitudinal recesses 14 are shown. The floor display further comprises a first picture 16 placed below the cover 10, and a second cover 18 is also illustrated which second cover 18 is covering different sections of the clover 10. At the second cover 18, further advertisement is possible.

By a floor display 2, it is possible in shops or supermarkets to use this floor display 2 for advertising. Pictures comprising text can be placed below the cover 10, and people walking in shops or supermarkets will see the picture 16 and get the information.

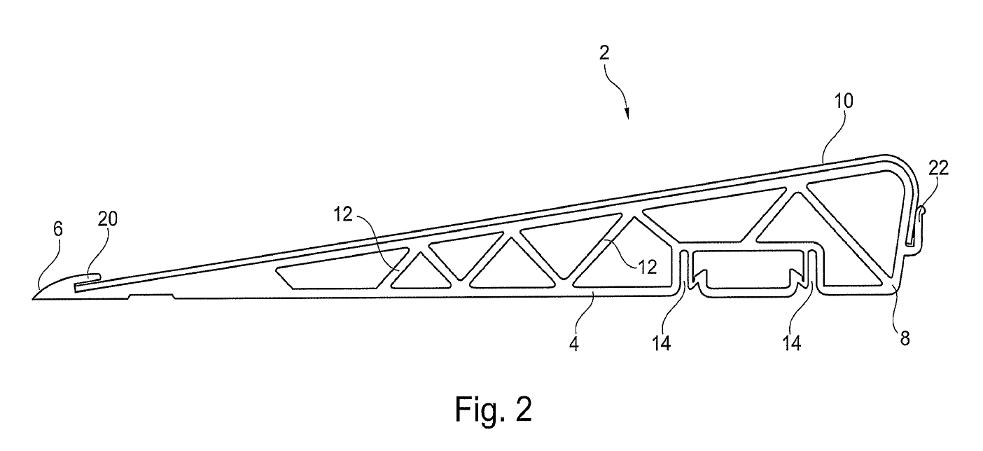

FIG. 2 shows a sectional view of a floor display 2. The bottom surface 4 is to be placed at the floor, and the front 6 end is pointing towards a room. The side 8 is supposed to be pointing towards a wall or a shelf. A cover 10 is shown at the top of the floor display and reinforcement braces 12 are shown inside the floor display. Recesses 14 are shown for accommodation of a protrusion fixed to the floor. A protrusion 20 covers the front of the cover 10, and a hook 22 is fixing the cover 10 at the side 8.

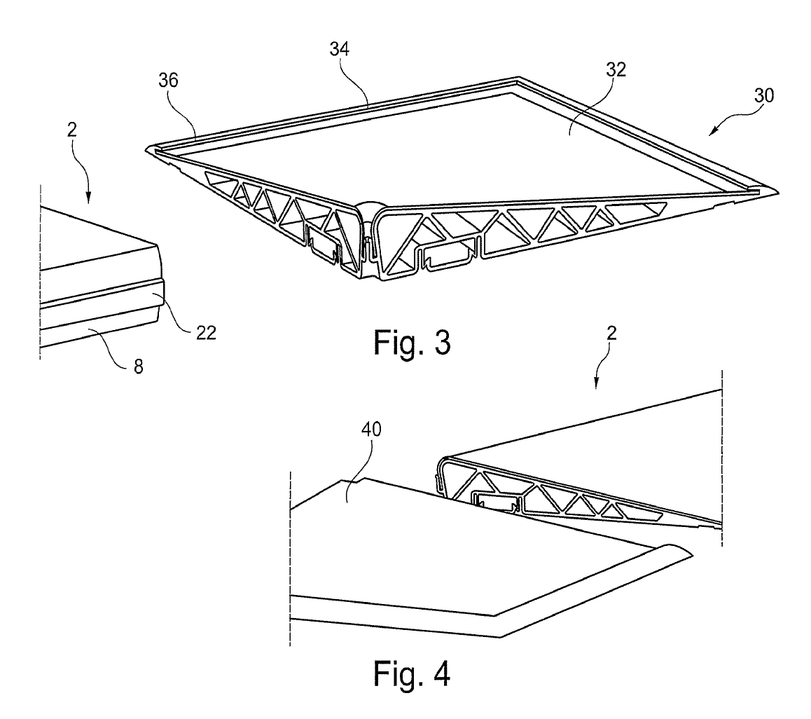

FIG. 3 shows corner sections forming an outside corner 30 which comprises display areas 32 and 34. A protrusion 36 is shown which could be used for fixing a not shown cover. The corner 30 can be connected to a longitudinal floor display 2.

FIG. 4 shows an end section 4 in combination with a floor display 2.

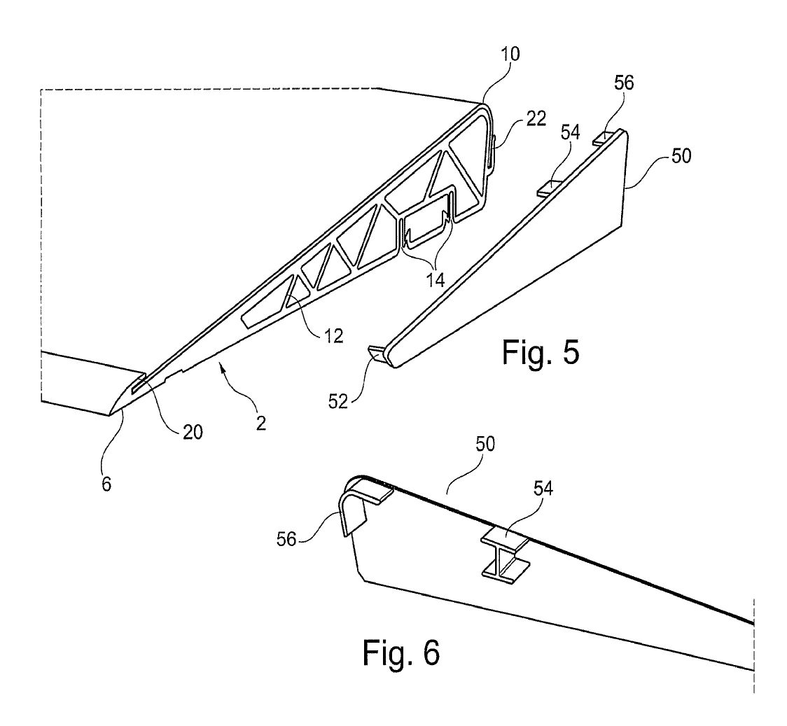

FIG. 5 shows an alternative end section 50 which is to be connected to the end of a floor display 2. The end section 50 comprises fixation means 52, 54 and 56 which are to fit into openings in the floor panel 2.

FIG. 6 shows the end panel 50 with the fastening means 54 and 56.

By a floor panel as described, it is possible to place a floor display around shelves in a supermarket. Information in relation to goods for sale on the shelves can be placed just below the goods. By using a floor display as described, it is possible to achieve a completely new area for advertisement. In order to be able to walk safely, people will usually watch the floor and automatically see the advertisement information. Therefore, floor advertisement is much more important than e.g. advertisement over the head of people as seen in supermarkets today.

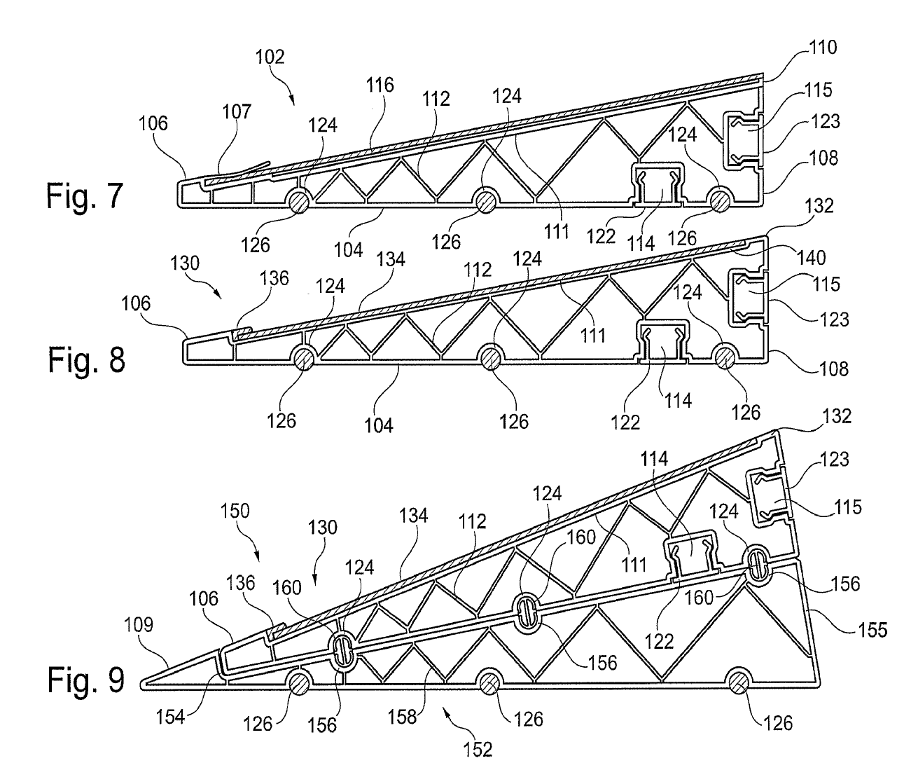

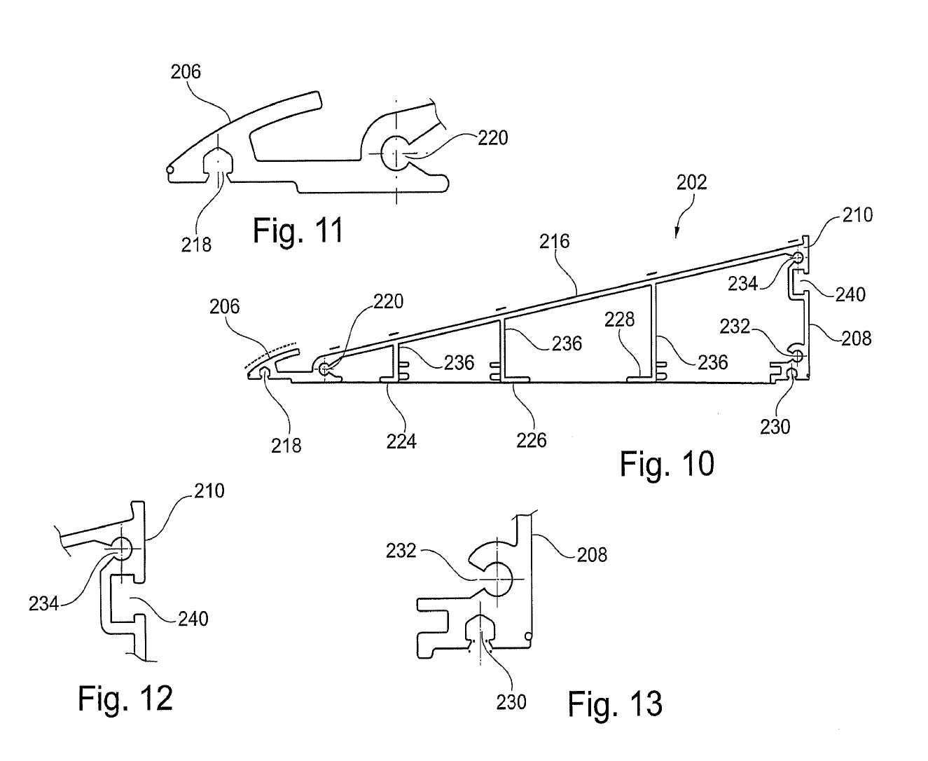

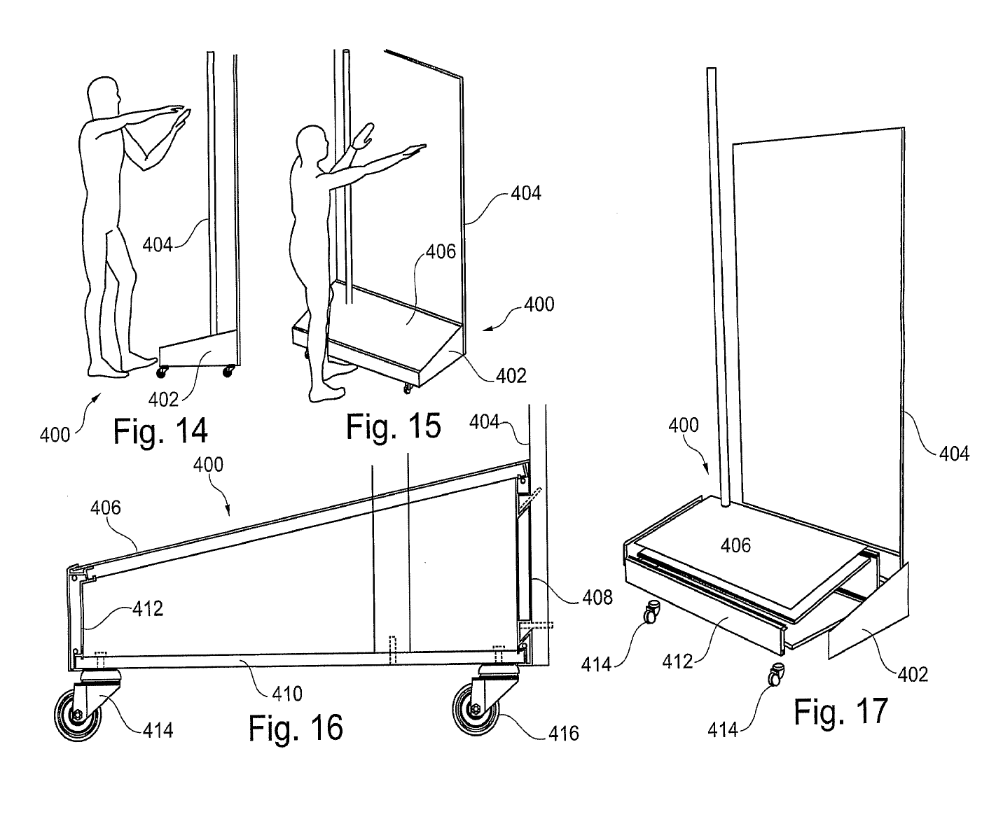

FIG. 7 shows an alternative embodiment for the invention shown in the previous figures. At FIG. 7, a floor panel 102 is shown which floor panel has a downward surface 104, a front 106 and a back 108. The back 108 ends in an upper corner 110. The floor display further comprises reinforcement braces 112. Furthermore, longitudinal recesses 114 are shown, which longitudinal recesses comprise an insert 122. The floor display 102 further comprises a cover 116 which covers e.g. a picture. The floor display 102 further comprises longitudinal recesses 124 which longitudinal recesses 124 comprise cylinders 126 which could be made of rubber or silicone.

FIG. 8 has common features with FIG. 7, and these features have the same numbers. These common features are as such not mentioned. At FIG. 8, an upper corner 132 is shown which differs from the corner 110 in FIG. 7, and similarly the cover 134 is also different from that in FIG. 7. The front 136 is also different from the front 106 seen in FIG. 7. The other features are similar.

FIG. 9 shows an alternative embodiment for the invention 150 which FIG. 9 shows a combination of two layers or the floor display where one display 130 as shown at FIG. 8 is placed on a carrier 152 for carrying the display 130 higher and at a different angle than shown at FIG. 8. The same numbers are used for the same components as previously, and only different components are mentioned. The carrier 152 comprises a recess 154 for accommodating the display 130. The carrier 152 comprises longitudinal recesses 156 where fasteners 160 are placed partly in the longitudinal recess 156 and in the longitudinal recesses 124. In this way, the display 130 and the carrier 152 are combined.

It is to be understood that further development of floor displays is possible. Not shown at the drawings further development could lead to a floor display where recesses 124 are also placed in the upper surface 111, so that e.g. a floor display as shown in FIG. 7 or FIG. 8 can be stacked if an increasing showing angle is preferred. In that way, the rubber cylinders 126 could be used, or another component more like the fastener 160 could be used for combining the two components. A recess 124 below the cover 134 or 116 will probably not affect the picture which could be placed below the cover. It is preferred that the embodiments shown in FIGS. 7, 8 and 9 could be extruded plastic materials. The cover 116 and 134 could be formed of a polycarbonate to give the cover sufficient resistance against scratches.

FIG. 10 concern an alternative embodiment for the invention. The floor display 202 comprises a front 206, a back 208 and an upper corner 210. A surface 216 is indicated for carrying an image and to be covered with a shield. In the front 206, a longitudinal cavity 218 is seen. A number of feet to carry the floor display are indicated as 224,226,228 as well as the corner 208. Furthermore, at the corner 208, a longitudinal recess 230 and a longitudinal recess 232 are indicated. Near the upper corner 210, a longitudinal recess 234 is shown. Inside the floor display, carrying supports 236 are shown which are connected to the different feet 224,226,228.

FIG. 11 is a magnified indication of the front 206 and shows the longitudinal recess 218 and 220.

FIG. 12 shows the upper corner 210, and here a circular recess 234 is indicated as well as a recess 240 for fastening.

Furthermore, in FIG. 13, the corner 208 is shown, and a first circular longitudinal recess 232 is indicated and a further recess 230.

It is to be understood that the floor display in FIGS. 10, 11, 12 and 13 is formed of a metal which can be extruded. One possible material for the floor display would be aluminium, but it is to be understood that other materials and other metal alloys could be used instead of pure aluminium.

FIG. 14 shows an alternative embodiment for the invention by a floor display 400 which has a side 402 and an upstanding wall 404. On the wall 404, it is possible to place a number of shelves or hanging means for the display for clothes.

FIG. 15 shows the same embodiment as FIG. 14 of the moveable floor display 400. Furthermore, in FIG. 15, the side 402 is indicated and also the display wall 404. This figure also shows the floor display 406 placed at the top of the display 400.

FIG. 16 shows a sectional view of a moveable floor display 400. The floor display 400 comprises the upper display screen 406 and a back 408 to which back the wall 404 is connected. The moveable floor display 400 also comprises a bottom section 410 and a front section 412. Below the moveable floor display 400, wheels are indicated 414 and 416.

FIG. 17 shows the moveable floor display 400 partly separated. The side 402 is removed so it is open to the inside of the floor display. The wall 404 is also indicated. The top plate is now shown with 406 and below that plate, a further plate is indicated. The top plate 406 could be a transparent material where the plate below is covering a picture or a text. Further, a front 412 is indicated and two front wheels 414.

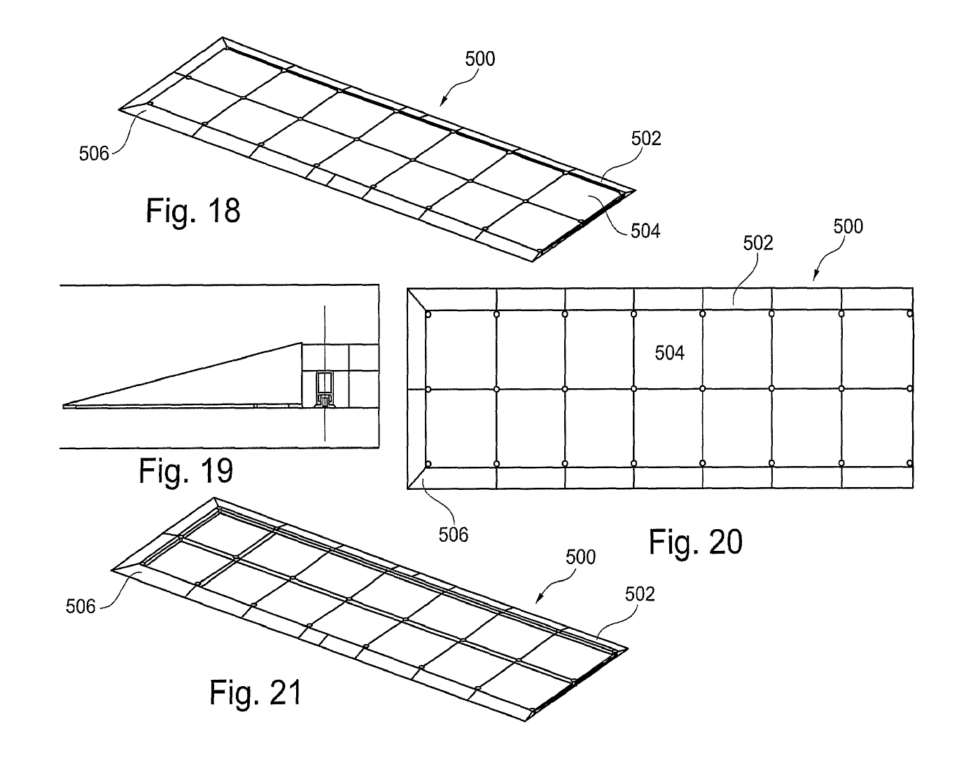

FIG. 18 shows an elevated floor 500 operating with floor displays around the three sides. The floor itself comprises floor plates 504, and the floor display also comprises corner sections 506 so that the floor display can be placed around the corners of a floor 504.

FIG. 19 simply shows the floor display seen from the side where it is connected to the floor.

FIG. 20 shows the elevated floor 500 in combination with floor display 502. This figure also shows corner sections 506.

FIG. 21 shows the same elevated floor 500 with the floor display 502 and 506 but without floor plates.

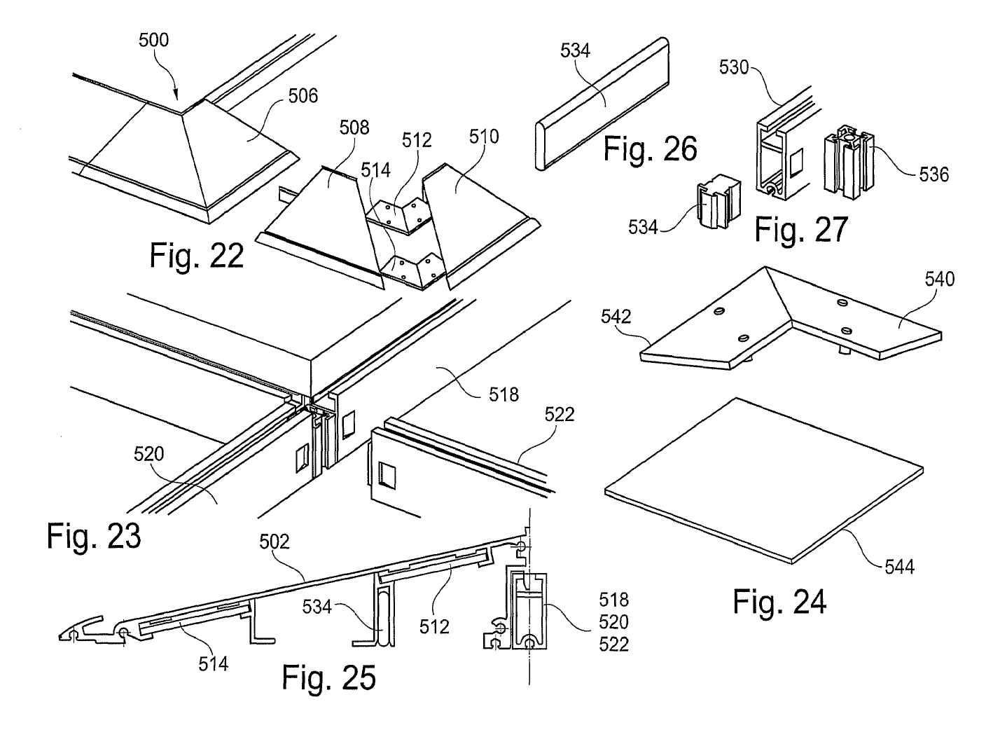

FIG. 22 shows two separated corner sections 508 and 510 and indicates that flanges 512 and 514 are used in slots in the corner sections 508 and 510. These sections are placed in the slots and are as such fixing the two corner sections to each other. Holes are indicated in the flanges 512 and 514, and they could in fact be fastened by screws to these holes so that further fastening is achieved.

FIG. 23 shows the elevated floor which is built by carriers 518, 520 and 522. These carriers can be interconnected by connection sections which are shown in FIG. 27 as 536.

FIG. 24 shows another embodiment for a corner which is made of floor display sections 340, 542 which are cooperating with floor sections 544.

FIG. 25 shows a sectional view of a floor display 502, and inside the floor display flanges 512, 514 are indicated for fastening different flanges to each other. Further stability is achieved by a plastic component 534 which is also placed in a longitudinal slit in the floor panel.

FIG. 26 shows the longitudinal component.

FIG. 27 shows different mechanical components 530, 534 and 536 which are used for forming a floor.

It is to be seen at the figures that a very flexible floor display can be achieved.

1. A floor display (29) comprising a floor panel, which floor display comprises a bottom surface (4) to be placed at the floor, a side surface (8) to be placed against a wall or a shelf, which floor display (2) comprises an upper surface, which upper surface of the floor display mostly follows a line from the front of the bottom surface (4) to the top of the side surface (8), hereby forming an inclined panel, characterized in that the upper surface of the floor display (2) forms a display area, which display surface is covered by a transparent cover (10), which transparent cover (10) is fixed to the floor display (2) at the front (6) and at the side surface (8) against the wall or shelf, which floor display comprises reinforcement braces (12) connecting the top and bottom (4) of the floor display (2).

2. A floor display according to claim 1, characterized in that the front (6) of the floor display comprises a protrusion (20), which protrusion (20) overlay the front of the transparent cover (10).

3. A floor display according to claim 1, characterized in that the side surface (8) of the floor display (2) comprises an upwards directed hook (22) for fastening the back of the transparent cover (10).

4. A floor display according to claim 1, characterized in that the transparent cover (10) is formed of polycarbonate.

5. A floor display according to claim 1, characterized in that a space for accommodation of a display media is formed in the floor display below the transparent cover (10).

6. A floor display according to claim 5, characterized in that the display media is a printed picture.

7. A floor display according to claim 5, characterized in that the display media is an electronic display.

8. A floor display according to claim 1, characterized in that the bottom of the floor display comprises at least one recess (14) for accommodation of a protrusion, which protrusion is part of the longitudinal frame fastened to the floor.

9. A floor display according to claim 1, characterized in that the floor display comprises a computer controlled display, which display is covered by a full or partly transparent cover.

10. A floor display according to claim 1, characterized in that the floor display comprises a number of LED based light sources place below a full or partly transparent cover.

11. A floor display according to claim 1, characterized in that the floor display comprises a cable tray for power or data cables.

12. A floor display according to claim 1, characterized in that the floor display comprises hinge in the front end for adjustment of the inclined panel in order to fit shelves at different heights over the floor.
